(19) United States
(12) Patent Application Publication
(10) Pub. No.: US 2005/0156398 A1
(43) Pub. Date: Jul. 21, 2005

(54) Device for leveling a trailer floor

(76) Inventor: John Edward Ramsey, Canton, OH (US)

Correspondence Address: DAVID P DURESKA;BUCKINGHAM DOOLITTLE & BURROUGHS, LLP, 4518 FULTON DRIVE, NW, P O BOX 35548, CANTON, OH, 44735-5548, US

(21) Appl. No.: 10/759,590

(22) Filed: Jan. 16, 2004

(51) Int. Cl. B60G 9/02

(52) U.S. Cl. 280/124.116

(57) ABSTRACT

An axle/suspension system for the trailer of a tractor-trailer vehicle combination includes a device for leveling the trailer floor. A selected one of a pair of suspension assemblies of the system is pivotally attached to a vehicle frame bracket or hanger having vertically-oriented oval sidewall openings and vertically-spaced horizontally extending eccentric collar guide tabs. The frame hanger, upon a certain manual rotational adjustment of an eccentric alignment collar with a breaker bar, causes a bolt which pivotally attaches the suspension assembly beam to the hanger to be vertically adjusted, which in turn causes vertical adjustment of the beam and the axle attached to the beam, resulting in the raising or lowering of a sidewardly leaning trailer floor to a generally horizontally level position.

### BACKGROUND OF THE INVENTION

1. Technical Field

The invention relates to tractor-trailers and specifically to the axle/suspension systems that support the trailers of such heavy-duty vehicles. More particularly, the invention is directed to a modified adjustment device of the axle/suspension system which enables the floor of the trailer to be horizontally leveled.

2. Background Art

Heavy-duty vehicles such as semi-trailers or tractor-trailers typically include a trailer, which can be one of various types that are well-known in the heavy-duty vehicle art, and include van trailers and flatbed trailers. These types of tractor-trailers also have heavy-duty axle/suspension systems which depend from the vehicle frame and suspend the wheels and tires from the trailer to provide a smooth ride to the cargo being carried by the trailer as well as to any occupants of the tractor cab.

It is well-known in the tractor-trailer art that the axles of the axle/suspension systems periodically require realignment to ensure that the longitudinal center line of the trailer is perpendicular to each transversely extending axle. Such alignment is necessary to ensure proper tracking of the vehicle tires, which in turn reduces tire wear and extends the life of other vehicle components which otherwise would be adversely affected. This alignment traditionally has been accomplished by a well-known adjustment device which is part of the fastening means used to pivotally attach the suspension assemblies of each axle/suspension system to hangers which are affixed to and depend from the vehicle frame.

More specifically, this device includes an eccentric alignment collar through which the pivot fastener bolt passes. The collar can be manually turned about the bolt when its nut is loosened by using a breaker bar. A horizontally-oriented elongated opening formed in each sidewall of the hanger, and through which the pivot bolt passes, allows limited fore-aft movement of the bolt, and thus of the suspension assembly and axle connected thereto, to achieve proper axle alignment. However, it typically is not necessary to have such an axle alignment capability on each of the spaced-apart frame hangers which each support a suspension assembly of an axle/suspension system. Nonetheless, most prior art tractor-trailers incorporate the above-described alignment device, or a variation thereof, into each frame hanger which supports a suspension assembly.

However, a common problem often can be found in the trailers of such tractor-trailers. More particularly, during construction by the trailer manufacturer, the floor of the trailer, particularly in flatbed-type trailers, is prone to warpage. Specifically, a trailer occasionally is built with the bottom surfaces of the elongated and longitudinally-extending main frame rails at different distances from the actual trailer floor, and since each axle/suspension system is mounted on those main rails via the frame hangers, the end result often is a trailer floor that is tilted or leaning to one side when viewed from the rear of the trailer. Purchasers and users of these trailers find such trailer lean or tilt undesirable, if only from an aesthetic standpoint.

The present invention solves the above-described problem of trailer lean or tilt associated with prior art tractor-trailers incorporating axle/suspension systems having only the above-described axle alignment device, by modifying the device on one of the suspension assembly hangers of each axle/suspension system into a trailer floor leveling device.

### SUMMARY OF THE INVENTION

Objectives of the invention include providing a device for horizontal leveling of the floor of a trailer of a tractor-trailer combination.

Another objective of the present invention includes providing a trailer leveling device that is easy to install, economical and simple to use.

These objectives and advantages are obtained by the axle/suspension system for a trailer of a tractor-trailer vehicle combination of the present invention, the trailer including a floor mounted on a longitudinally-extending frame of the trailer, the axle/suspension system including a pair of transversely-spaced suspension assemblies, each one of the suspension assemblies including a longitudinally-extending beam, the beams capturing a transversely-extending axle, means for pivotally mounting each one of the beams on a bracket mounted on and depending from the trailer frame, the pivotal mounting means including a bolt passing through aligned openings formed in a pair of transversely-spaced inboard and outboard sidewalls of the bracket and being secured thereto with a nut, wherein the improvement comprises, the bracket sidewall openings each being generally elongated and vertically disposed, and means for vertically moving the bolt in the openings, so that upon loosening of the nut on the bolt and selective adjustment of the bolt movement means in a certain direction, the bolt, the beam, and the axle are vertically adjusted for transversely horizontally leveling the trailer floor.

### BRIEF DESCRIPTION OF THE DRAWINGS

The preferred embodiment of the invention, illustrative of the best mode in which applicant has contemplated applying the principles, is set forth in the following description and is shown in the drawings and is particularly and distinctly pointed out and set forth in the appended claims.

FIG. 1 is a fragmentary perspective exploded view of a prior art driver's side hanger, showing the manner in which a suspension assembly typically is pivotally attached to the hanger;

FIG. 2 is a top plan view of an axle/suspension system of a tractor-trailer mounted on a pair of the spaced-apart prior art frame hangers shown in FIG. 1;

FIG. 3A is a driver's side elevational view of the axle/suspension system shown in FIG. 2, and further showing the direction F′ in which a breaker bar is rotated from the illustrated starting position to a first adjustment position, to in turn rotate an eccentric alignment collar and adjust the driver's side axle end in a frontward direction F;

FIG. 3B is a view similar to FIG. 3A, but showing the breaker bar and alignment collar rotated to the first adjustment position, and the driver's side axle end adjusted in the frontward direction;

FIG. 4A is a view similar to FIG. 3A, but showing the direction R′ in which the breaker bar is rotated from the illustrated starting position to a second adjustment position, to in turn rotate the alignment collar and adjust the driver's side axle end in a rearward direction R;

FIG. 4B is a view similar to FIG. 4A, but showing the breaker bar and alignment collar rotated to the second adjustment position, and the driver's side axle end adjusted in the rearward direction;

FIG. 5 is a curbside perspective view of the frame hanger of the present invention, configured for enabling vertical adjustment of the curbside end of the axle of an axle/suspension system connected to the hanger via a suspension assembly beam;

FIG. 6 is a rear end view of a flatbed trailer of a tractor-trailer, and showing the rearwardmost axle/suspension system having wheels and tires mounted on each end of the axle, with the wheels and tires being represented in phantom lines and resting on ground shown in fragmentary cross-section, and further illustrating the trailer bed leaning transversely down in the curbside direction;

FIG. 7A is a curbside elevational view of the axle/suspension system shown in FIG. 6, and further showing the direction U′ in which a breaker bar is rotated from the illustrated starting position to a third adjustment position, to in turn rotate an eccentric alignment collar and adjust the curbside axle end in an upward direction U;

FIG. 7B is a view similar to FIG. 7A, but showing the breaker bar and alignment collar rotated to the third adjustment position, and the curbside axle end adjusted in the upward direction;

FIG. 8A is a view similar to FIG. 7A, but showing the direction D′ in which the breaker bar is rotated from the illustrated starting position to a fourth adjustment position, to in turn rotate the alignment collar and adjust the curbside axle end in a downward direction D; and

FIG. 8B is a view similar to FIG. 8A, but showing the breaker bar and alignment collar rotated to the fourth adjustment position, and the curbside axle end adjusted in the downward direction.

Similar numerals refer to similar parts throughout the drawings.

### DESCRIPTION OF THE PREFERRED EMBODIMENT

Heavy-duty combination tractor-trailers, also known as semi-trailers, typically have a cab or tractor which holds the driver of the vehicle and any passengers and pulls a trailer. The pulled trailer can be one of any of various types, such as van trailers which are generally rectangular-shaped box-like structures that are commonly seen traveling over-the-road. Another common trailer is the flatbed-type which generally only have a floor for carrying cargo, but the cargo typically is not fully enclosed as in the van-type trailer, although a flatbed trailer can have sidewalls and/or tarp covers, if desired. Various other types of trailers also exist, but one common denominator in all such trailers is that they have a floor.

A rear-end view of a flatbed trailer, which incorporates the device of the present invention for leveling a floor as will be described in detail hereinbelow, is indicated generally at 10 and is shown in FIG. 6. Trailer floors can be constructed in various manners and with different types of materials, but all of these floors usually are flat, horizontally-oriented and rectangular-shaped structures. Floor 11 of flatbed trailer 10, and as is customary with other types of trailers, is built on a pair of transversely-spaced main rails 12 which can have a configuration such as an I-beam shape as shown and extend longitudinally the entire length of the trailer.

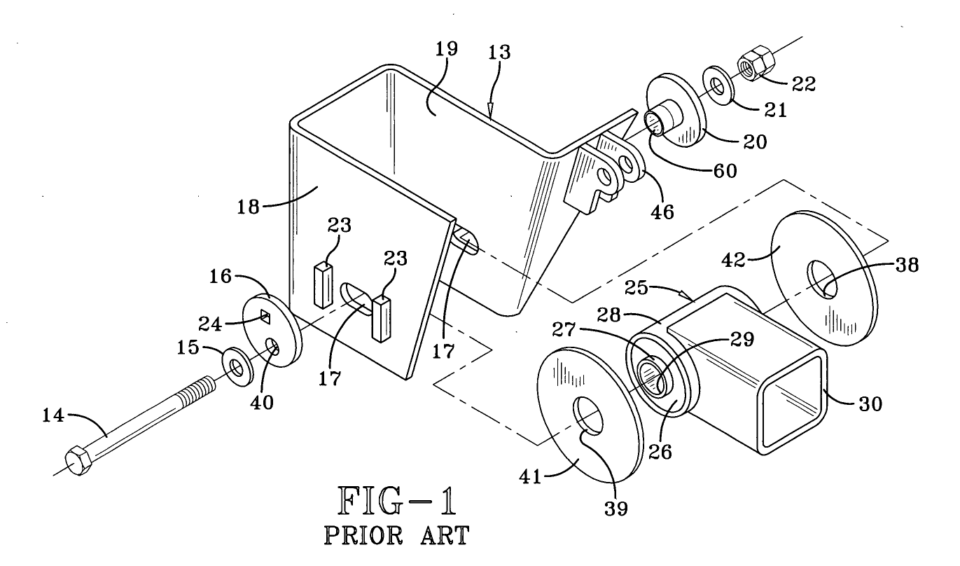

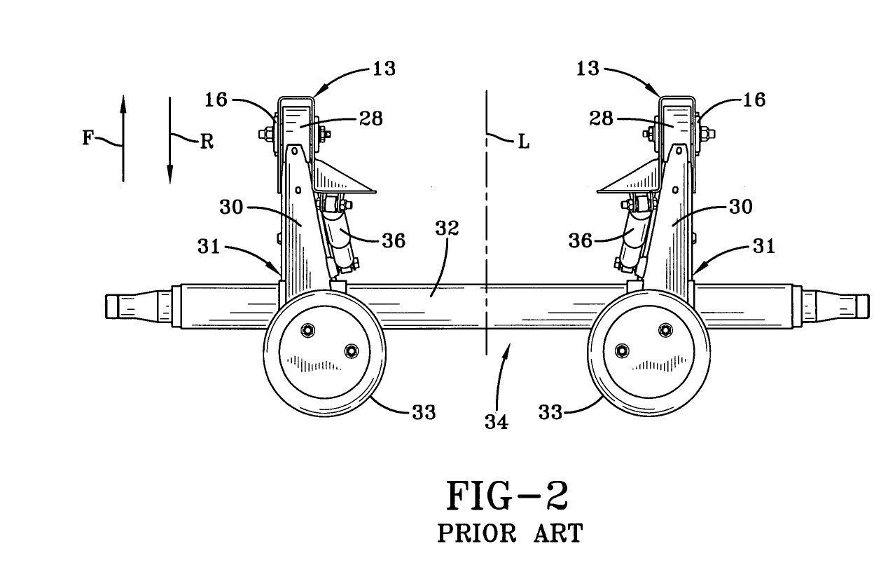

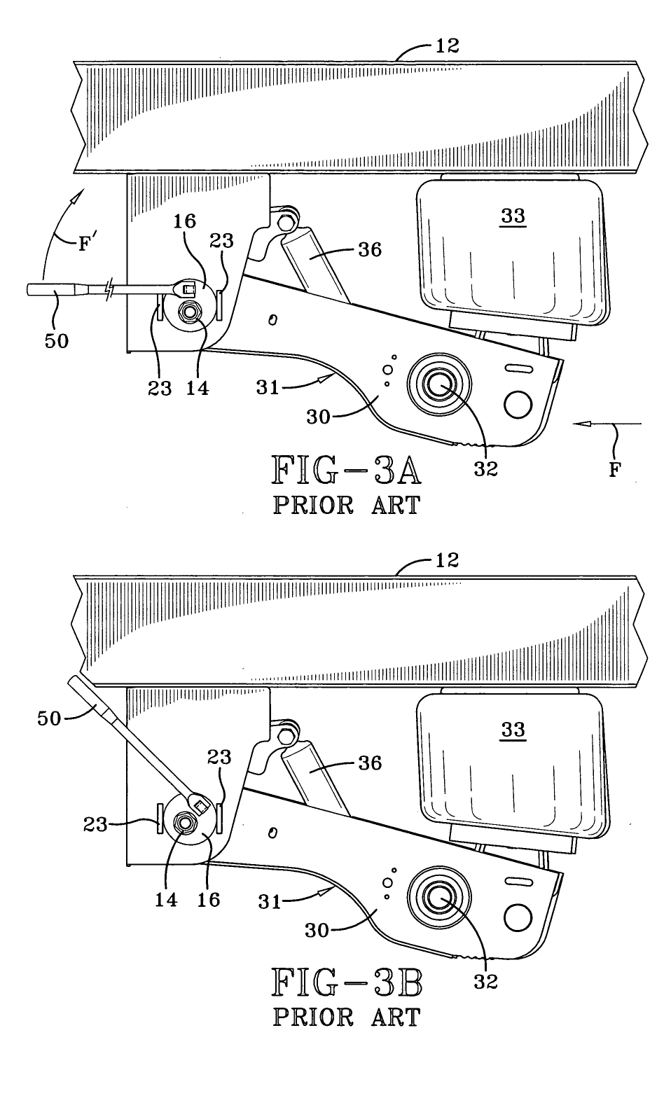

As best shown in FIG. 2, which illustrates a prior art axle/suspension system indicated generally at 34, each one of a pair of spaced-apart prior art frame hangers or brackets 13 typically is secured to the bottom of a respective one of the vehicle frame main rails (not shown) and depends downwardly therefrom. Many prior art frame hangers are of the type indicated at 13 and shown in FIG. 1 and are specially configured, as will be described in greater detail below, to enable fore-aft alignment of an axle 32 of axle/suspension system 34. Mounted on each frame hanger 13 is a suspension assembly 31, as best shown in FIGS. 2 and 3A.

Each suspension assembly 31 includes, at its frontwardmost end, a bushing assembly 25. Bushing assembly 25 includes an elastomeric bushing 26 secured to and about, typically with an adhesive, a metal mounting sleeve 27 formed with a continuous opening 29. Bushing 26 in turn is secured in a usual manner in a metal mounting tube 28. Tube 28 is attached to a suspension arm or beam 30, usually by welding. Bushing assembly 25 is captured between a pair of spaced-apart outboard and inboard sidewalls 18 and 19, respectively, of generally U-shaped hanger 13.

More particularly, a bolt 14 passes from the outboard side of hanger 13, through a washer 15, and through an offset opening 40 formed in an eccentric alignment collar 16. Bolt 14 continues through a horizontally disposed, generally oval-shaped opening 17 formed in outboard sidewall 18 of hanger 13, through an opening 39 formed in an outboard wear pad 41, through bushing assembly sleeve opening 29, through an opening 38 formed in an inboard wear pad 42, and through a similarly shaped and aligned horizontally disposed opening 17 formed in inboard hanger sidewall 19. Bolt 14 then is passed through an opening 60 formed in a concentric collar 20 which locates in inboard sidewall opening 17, and a washer 21. A torque nut 22 secures together bolt 14, washer 15, alignment collar 16, bushing assembly sleeve 27, wear pads 41, 42, collar 20 and washer 21.

Eccentric alignment collar 16 is located between a fore-aft spaced pair of vertically extending alignment guide tabs 23. Alignment collar 16 is formed with an opening 24 for receiving a breaker bar 50. Breaker bar 50 is used for adjustment of axle alignment, as will be described below. Suspension beam 30 thus is pivotally mounted on and extends rearwardly from frame hanger 13.

Beam 30 captures transversely extending axle 32 which extends outboardly from the beams. It is understood that wheels, tires and the like are mounted on each end of axle 32 as is well-known to those skilled in the heavy-duty vehicle art. A shock absorber 36 is mounted on and extends between a bracket 46 attached to hanger 13, and beam 30, and a ride air spring 33 is mounted on and extends between the rearwardmost upper surface of the beam and its respective main rail 12. A similar suspension assembly 31 is mounted on opposite main rail 12 and frame hanger 13 to complete axle/suspension system 34.

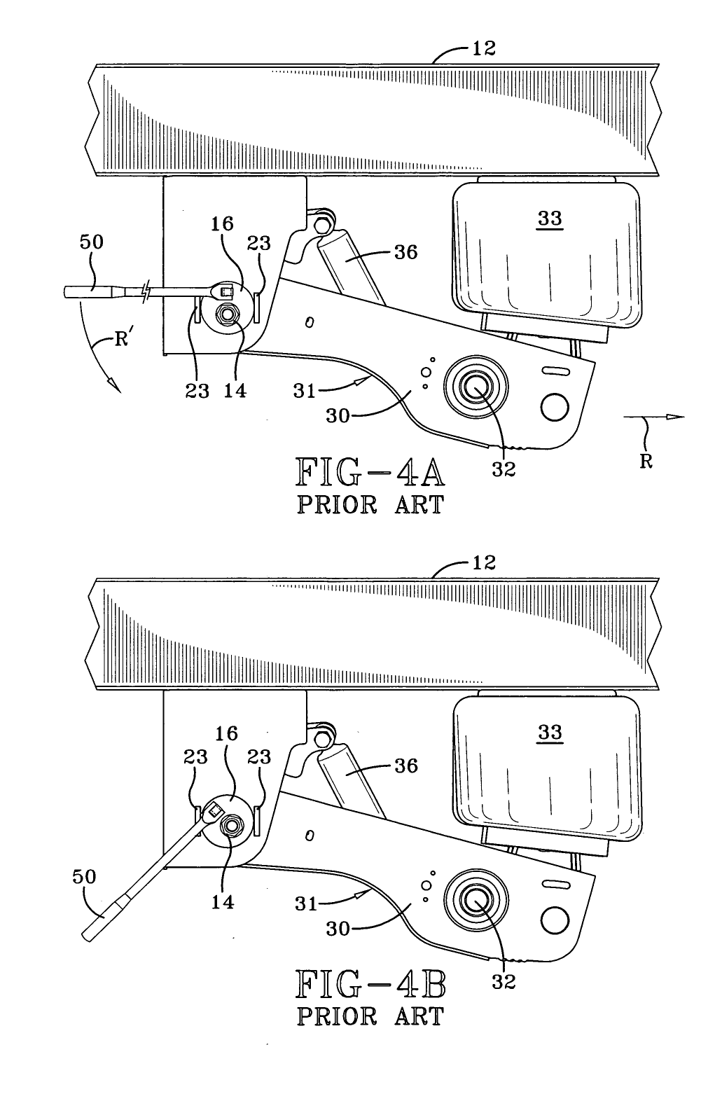

It is well-known in the prior art that frame hanger 13 of the type shown in FIG. 1 was utilized on each suspension assembly 31 of axle/suspension system 34. This arrangement enabled fore-aft adjustment of either driver's side or curbside end of axle 32 in order to align the axle with or make it perpendicular to a longitudinal center line L (FIG. 2) of the trailer to which the axle is attached for proper tracking of the vehicle tires. Referring now to FIGS. 2-4, in order to adjust the driver's side end of axle 32 forward in the direction of arrow F in FIG. 2, a breaker bar 50 is inserted in opening 24 of alignment collar 16 in the manner shown in FIG. 3A, and rotated upwardly in the direction of arrow F′ to a first adjustment position shown in FIG. 3B. This upward rotation of breaker bar 50 in turn causes rotation of eccentric alignment collar 16, which is captured between alignment guide tabs 23. It can be seen by comparing FIG. 3B to FIG. 3A that this rotation causes bolt 14 to move frontwardly in hanger horizontal openings 17, thereby causing beam 30 of suspension assembly 31 pivotally mounted on the bolt and the driver's side end of axle 32 rigidly attached to the beam to be moved frontwardly and make the axle perpendicular to trailer longitudinal centerline L. Conversely, if the driver's side end of axle 32 needs to be adjusted rearwardly to achieve axle alignment, as represented by arrow R in FIG. 2, breaker bar 50 is rotated downwardly in the direction of arrow R′ shown in FIG. 4A, to a second adjustment position shown in FIG. 4B. The same frontward or rearward axle alignment can be achieved (not shown) on curbside hanger 13 in a similar manner, if desired. However, it is redundant to have such an axle alignment adjustment device adjacent to each end of axle 32.

The present invention capitalizes on such redundancy to solve a problem inherent in the prior art, namely, the sideward leaning or tilting condition found in floor 11 of many trailers such as flatbed trailer 10, as best shown in FIG. 6. More particularly, when such trailers are manufactured, main rails 12 can be, due to warpage of the framework used to build trailer floor 11, different distances from a ground surface 35 on which trailer tires 37 rest.

More specifically, and as shown in FIG. 6, the uppermost surface of curbside rail 12 can be a distance X-a from ground 35 and the uppermost surface of driver's side rail 12 can be a larger distance X from the ground. Thus, trailer floor 11 leans or tilts to one side, wherein the driver's side of floor 11 of the trailer is a larger distance X from ground 35 while the passenger or curbside of trailer floor 11 is a smaller distance X-a from the ground, thereby causing a tilt or lean of the floor downward on the curbside. Of course, the opposite problem also occurs where the curbside of trailer floor 11 is a longer distance X from ground 35 and the driver's side is a shorter distance X-a from the ground, thereby resulting in downward trailer lean toward the driver's side (not shown).

The above-described tilt or lean problem is remedied by the device for leveling a trailer floor of the present invention. The device includes nearly all of the components of the axle alignment device described hereinabove, so only the modifications to that device will be indicated hereinbelow. More particularly, the only difference between the prior art axle alignment device and the trailer floor leveling device of the present invention, is that prior art frame hanger 13 is replaced by new frame hanger 43 on either the driver's side or the curbside suspension assembly 31, leaving hanger 13 on the opposite side for fore-aft axle alignment using the prior art axle alignment device described hereinabove.

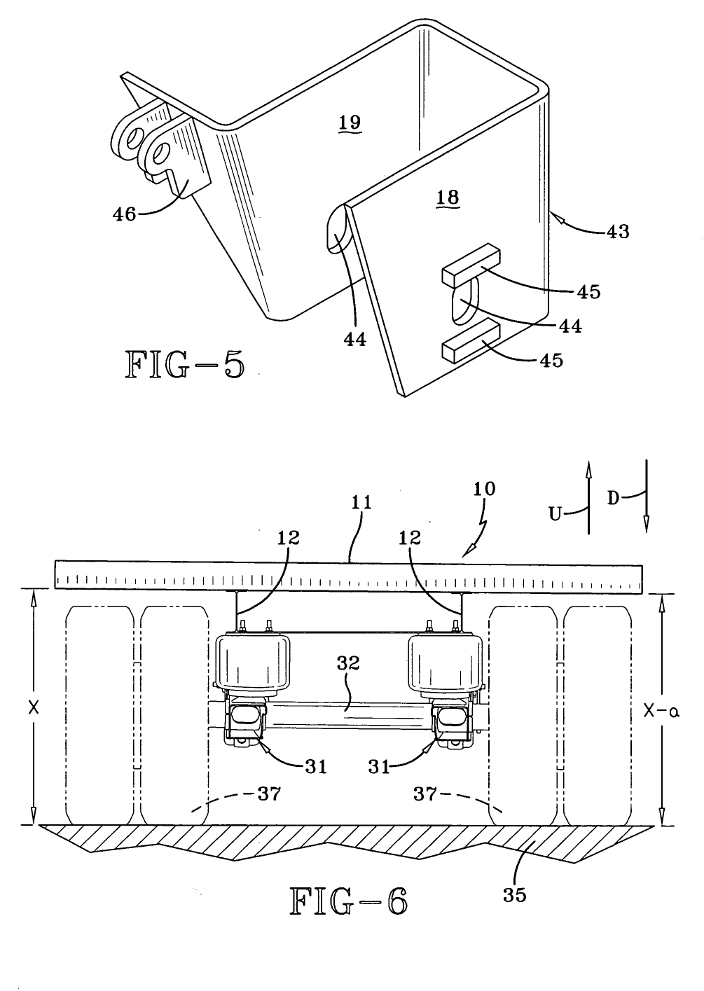

As illustrated in FIG. 5, hanger 43, shown here as the curbside hanger, is formed with a vertically extending oval-shaped opening 44 in each one of its outboard and inboard sidewalls 18, 19, respectively, and a pair of horizontally extending vertically-spaced leveling guide tabs 45 formed on the outboard sidewall. It is understood that if it is desired to incorporate the leveling device of the present invention on a driver's side hanger, then that hanger would be a mirror image of hanger 43. This design of hanger 43 enables adjustment of the curbside axle in a vertical direction rather than the fore-aft direction described hereinabove for axle alignment.

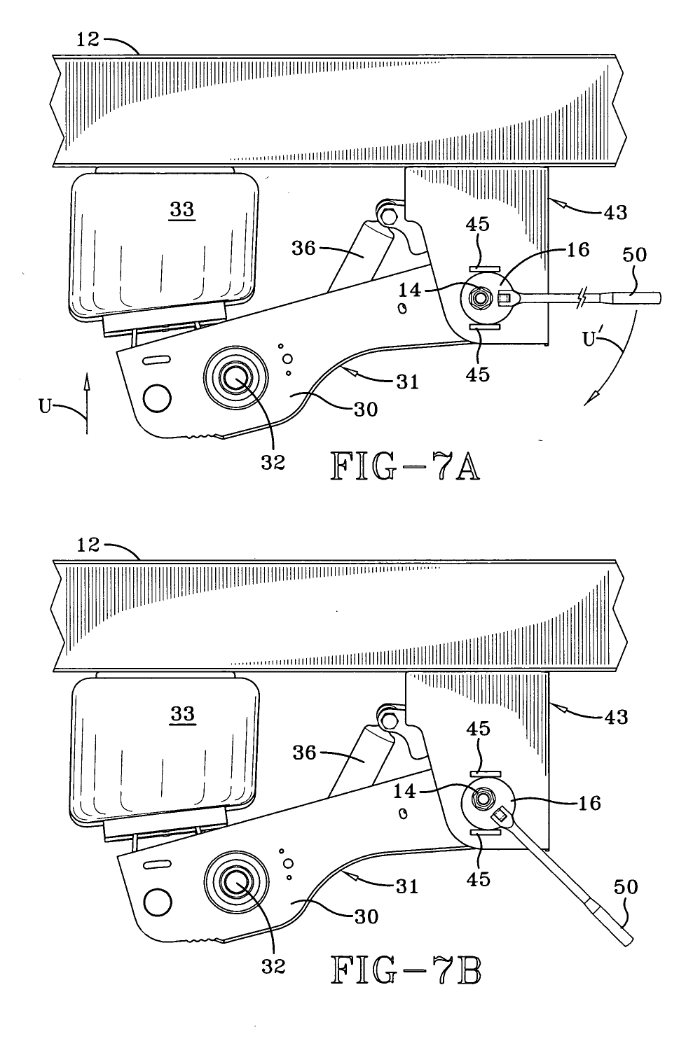

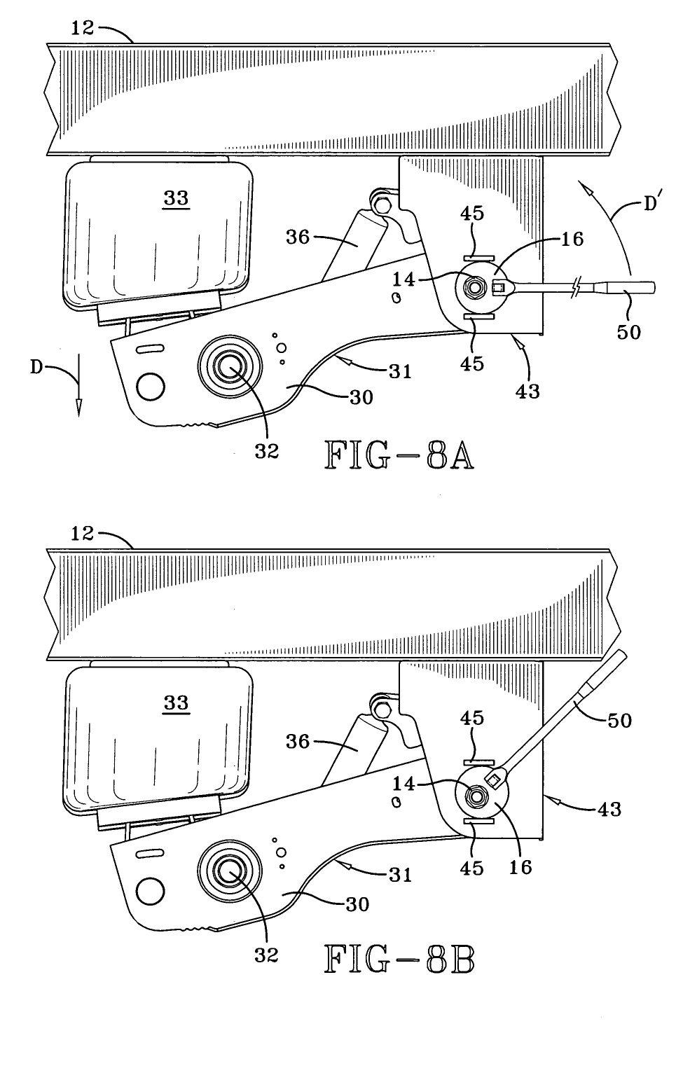

The manner of operation of the floor leveling device of the present invention to level floor 11 of trailer 10 now will be described. Specifically, breaker bar 50 is inserted in breaker bar opening 24 formed in eccentric alignment collar 16 of curbside hanger 43, as best shown in FIG. 7A. Assuming that trailer floor 11 is leaning in the curbside downward direction as illustrated by distance X-a as shown in FIG. 6, breaker bar 50 then is rotated downwardly in the direction of arrow U′ to a third adjustment position shown in FIG. 7B. This downward rotation of breaker bar 50 in turn causes rotation of eccentric alignment collar 16, which is captured between horizontal leveling guide tabs 45. It can be seen by comparing FIG. 7B to FIG. 7A that this rotation causes bolt 14 to move upwardly in hanger vertical openings 44, thereby causing curbside end of axle 32 and wheels/tires 37 to be moved upwardly and effectively raise (as represented by arrow U in FIGS. 6 and 7A) the bottom surface of trailer floor 11 to a distance of X (not shown) from ground 35, which is equal to the distance X of the driver's side of the trailer floor. If trailer floor 11 is leaning in the opposite direction, that is, the trailer floor is lower on the driver's side than the curbside, breaker bar 50 is inserted in eccentric alignment collar opening 24 as shown in FIG. 8A, and rotated in the direction of arrow D′ to a fourth adjustment position shown in FIG. 8B, to move the curbside end of axle 32 in a downward direction (as represented by arrow D in FIGS. 6 and 7A) to level the floor of trailer 10. Again, it is important to note that the aligned vertical openings 44 formed in sidewalls 18 and 19 of novel frame hanger 43, enable the up and down movement of bolt 14 and therefore beam 30 of suspension assembly 31 pivotally mounted on the bolt and axle 32 rigidly attached to the beam, to effectively raise or lower one side of trailer floor 11. The horizontally-oriented and vertically spaced leveling guide tabs 45 limit the movement of eccentric alignment collar 16 as it is being rotated.

It is understood that while the illustrated suspension assemblies 31 on which the leveling device of the present invention is incorporated are of the trailing arm type, the concepts of the present invention can be effectively applied to suspension assemblies of the leading arm type as well as to other types of suspension assemblies, beams and axles. Suspension assembly 31 is merely illustrative of one type of suspension assembly to which the device of the present invention can be applied. It also is understood that the leveling device of the present invention could be utilized on the driver's side rather than the curbside of a vehicle trailer, with the curbside suspension assembly incorporating prior art hanger 13 designed for fore-aft axle alignment, without affecting the overall concepts of the present invention. Moreover, it is understood that the starting and adjustment positions of bolt 14, eccentric collar 16 and breaker bar 50 shown in FIGS. 7A, 7B, 8A, and 8B are merely for illustration, and such positions can be different, without affecting the overall concepts of the invention. Of course, users of the inventive leveling device will be given detailed instructions on how to adjust their particular leveling device in view of the particular suspension assembly with which it is being used.

It is further understood that the concepts of the present invention are applicable to variations of prior art frame hanger 13 utilizing eccentric collar 16, vertically extending guide tabs 23 and horizontally disposed sidewall openings 17 as the fore-aft alignment device for axle 32. For example, the present invention can be applied to a prior art axle alignment device such as one manufactured and sold by Reyco Granning Suspensions. Specifically, the Reyco Granning alignment device includes a fore-aft horizontally disposed bolt to move a collar through which the suspension assembly pivot shaft passes. The bolt threadably engages the collar and, depending on the selected direction of rotation of the bolt, either pulls the collar forward or pushes it aft, which in turn moves the pivot shaft fore or aft, respectively, in horizontally-disposed generally oval-shaped openings formed in the frame hanger sidewalls. This pivot shaft movement in turn causes the suspension assembly pivotally mounted on the shaft and the axle end rigidly attached to the suspension beam to move with the pivot shaft to achieve axle alignment. Thus, to create a trailer floor leveling device, the frame hanger sidewall openings in the Reyco Granning device could be vertically disposed and the fore-aft horizontally disposed bolt could instead be disposed up-down vertically and be used to move the pivot shaft up and down within the frame hanger vertical openings to achieve trailer floor leveling.

Therefore, it is clear from this example that the concepts of the present invention can be effectively applied to any prior art axle alignment device that uses the concept of a suspension assembly pivot shaft or bolt passing through elongated, horizontally-disposed openings formed in the frame hanger sidewalls.

Accordingly, the improved device for leveling the floor of a trailer is simplified, provides an effective, safe, inexpensive and efficient structure which achieves all the enumerated objectives, provides for eliminating difficulties encountered with prior axle/suspension systems and trailers lacking such an adjustment device, and solves problems and obtains new results in the art.

In the foregoing description, certain terms have been used for brevity, clearness and understanding, but no unnecessary limitations are to be implied therefrom beyond the requirements of the prior art because such terms are used for descriptive purposes and are intended to be broadly construed.

Moreover, the description and illustration of the invention is by way of example, and the scope of the invention is not limited to the exact details shown or described.

Having now described the features, discoveries and principles of the invention, the manner in which the device for leveling the floor of a trailer is constructed, arranged and used, the characteristics of the construction and arrangement, and the advantageous, new and useful results obtained; the new and useful structures, devices, elements, arrangements, parts, processes, and combinations are set forth in the appended claims.

1. An axle/suspension system for a trailer of a tractor-trailer vehicle combination, said trailer including a floor mounted on a longitudinally-extending frame of the trailer, said axle/suspension system including a pair of transversely-spaced suspension assemblies, each one of said suspension assemblies including a longitudinally-extending beam, said beams capturing a transversely extending axle, means for pivotally mounting each one of said beams on a bracket mounted on and depending from said trailer frame, said pivotal mounting means including a bolt passing through aligned openings formed in a pair of transversely-spaced inboard and outboard sidewalls of said bracket and being secured thereto with a nut, wherein the improvement comprises:
said bracket sidewall openings each being generally elongated and vertically disposed, and means for vertically moving said bolt in said openings, so that upon loosening of said nut on said bolt and selective adjustment of said bolt movement means in a certain direction, said bolt, said beam, and said axle are vertically adjusted for transversely horizontally leveling said trailer floor.

2. The axle/suspension system of claim 1, in which said bolt movement means is an eccentric collar through which said bolt passes; in which a pair of vertically-spaced eccentric collar guide tabs is located on said outboard sidewall adjacent to and above and below said collar and said outboard sidewall opening; and in which upon rotation of the eccentric collar in a certain direction, said bolt, said beam, and said axle are vertically adjusted for transversely horizontally leveling said trailer floor.

3. The axle/suspension system of claim 2, in which each one of said eccentric collar guide tabs is an elongated generally longitudinally-extending tab; and in which said tab protrudes outboardly from said outboard sidewall.

4. The axle/suspension system of claim 1, in which each one of said bracket sidewall openings is generally oval-shaped.

5. The axle/suspension system of claim 1, in which said bracket is a generally U-shaped integral one-piece member having said pair of transversely-spaced sidewalls interconnected with a front wall.

6. The axle/suspension system of claim 1, in which said bolt movement means is a vertically disposed bolt; in which said vertically disposed bolt threadably engages a collar through which said pivot bolt passes; and in which upon rotation of said vertically disposed bolt in a selected direction, said collar, said pivot bolt, said beam, and said axle are vertically adjusted for transversely horizontally leveling said trailer floor.
